(19) United States
(12) Patent Application Publication
(10) Pub. No.: US 2025/0174411 A1
(43) Pub. Date: May 29, 2025

(54) TANTALUM CAPACITOR

(71) Applicant: SAMSUNG ELECTRO-MECHANICS CO., LTD., Suwon-si (KR)

(72) Inventors: Joung Hee CHO, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/909,086

(22) Filed: Oct. 8, 2024

(30) Foreign Application Priority Data
Nov. 27, 2023 (KR) 10-2023-0167128

(51) Int. Cl. H01G 9/042; H01G 9/04; H01G 9/048; H01G 9/052

(52) U.S. Cl. CPC H01G 9/042; H01G 9/048; H01G 9/0525; H01G 2009/05

(57) ABSTRACT

A tantalum capacitor includes a tantalum body including a tantalum element including tantalum powder, a conductive polymer layer disposed on the tantalum element, and a tantalum wire penetrating through at least a portion of each of the tantalum element and the conductive polymer layer in a first direction, a molded portion including a fifth surface and a sixth surface facing in the first direction, a third surface and a fourth surface facing in a second direction, and a first surface and a second surface facing in a third direction and surrounding the tantalum body, a first coating layer disposed in at least a portion of an interface between the tantalum body and the molded portion, and a second coating layer disposed on the first coating layer, wherein the second coating layer is thicker than the first coating layer.

### CROSS-REFERENCE TO RELATED APPLICATION(S)

This application claims benefit of priority to Korean Patent Application No. 10-2023-0167128 filed on Nov. 27, 2023 in the Korean Intellectual Property Office, the disclosure of which is incorporated herein by reference in its entirety.

### TECHNICAL FIELD

The present disclosure relates to tantalum capacitors, and more specifically, to a tantalum capacitor having improved reliability against stress and moisture resistance.

Tantalum (Ta) is a metal widely used across industries, including the electrical and electronics, mechanical engineering, chemical engineering, medical, as well as in the aerospace and defense industries, due to mechanical and physical characteristics thereof, such as a high melting point and excellent ductility and corrosion resistance.

In particular, tantalum is currently widely used as an anodic material for small capacitors due to characteristics thereof to form the most stable anodic oxide film among all metals.

Moreover, the use of tantalum materials has rapidly increased every year due to the recent rapid development of IT industries, such as electronics and information and communications.

Tantalum capacitors use a structure using an internal lead frame to connect a tantalum body to electrodes. Here, if sufficient adhesion between the internal lead frame and a molded portion is not secured, an interface defect may occur and moisture may penetrate through the corresponding interface. This may deteriorate the characteristics of tantalum capacitors in high temperature and humidity environments and affect reliability.

### SUMMARY

An aspect of the present disclosure is to provide a tantalum capacitor having excellent reliability by strengthening an interface to lower a moisture absorption rate.

Another object of the present disclosure is to provide a tantalum capacitor having enhanced characteristics against stress.

According to an aspect of the present disclosure, a tantalum capacitor includes a tantalum body including a tantalum element including tantalum particles, a conductive polymer layer disposed on the tantalum element, and a tantalum wire penetrating through at least a portion of each of the tantalum element and the conductive polymer layer in a first direction, a molded portion including a fifth surface and a sixth surface facing in the first direction, a third surface and a fourth surface facing in a second direction, and a first surface and a second surface facing in a third direction, the molded portion surrounding the tantalum body, a first coating layer disposed on at least a portion of a first interface between the tantalum body and the molded portion, and a second coating layer disposed on the first coating layer, wherein the second coating layer is thicker than the first coating layer.

According to another aspect of the present disclosure, a tantalum capacitor includes a tantalum body including a tantalum element including tantalum particles, a conductive polymer layer disposed on the tantalum element, and a tantalum wire penetrating through at least a portion of each of the tantalum element and the conductive polymer layer in a first direction, a molded portion including a fifth surface and a sixth surface facing in the first direction, a third surface and a fourth surface facing in a second direction, and a first surface and a second surface facing in a third direction, the molded portion surrounding the tantalum body, an anode lead frame extending to the second surface of the molded portion and electrically connected to the tantalum wire, a cathode lead frame spaced apart from the anode lead frame and extending to the second surface of the mold portion, a first coating layer disposed on at least a portion of a second interface between the molded portion and the anode lead frame and a third interface between the molded portion and the cathode lead frame, a second coating layer disposed on the first coating layer.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a tantalum capacitor according to the present disclosure;

FIG. 2 is a side perspective view of a tantalum capacitor according to the present disclosure;

FIG. 3 is a cross-sectional view taken along line I-I′ in FIG. 1;

FIG. 4 is an enlarged view of portion A in FIG. 3;

FIG. 5 is a cross-sectional view taken along line I-I′ of a modified example of the present disclosure;

FIG. 6 is an enlarged view of portion B in FIG. 5; and

FIG. 7 is a cross-sectional view of a tantalum capacitor in the related art.

### DETAILED DESCRIPTION

The exemplary embodiments in the present disclosure may be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and sizes of elements may be exaggerated for clarity.

Hereinafter, exemplary embodiments of the present disclosure will be described with reference to the accompanying drawings.

In the drawings, the X-direction may be defined as a first direction, an L direction, or a length direction, the Y-direction may be defined as a second direction, a W direction, or a width direction, and the Z-direction may be defined as a third direction, a T direction, or a thickness direction.

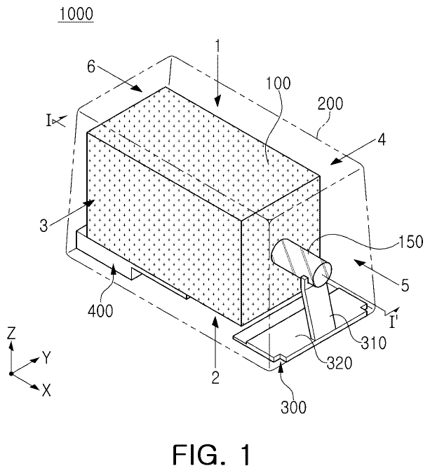

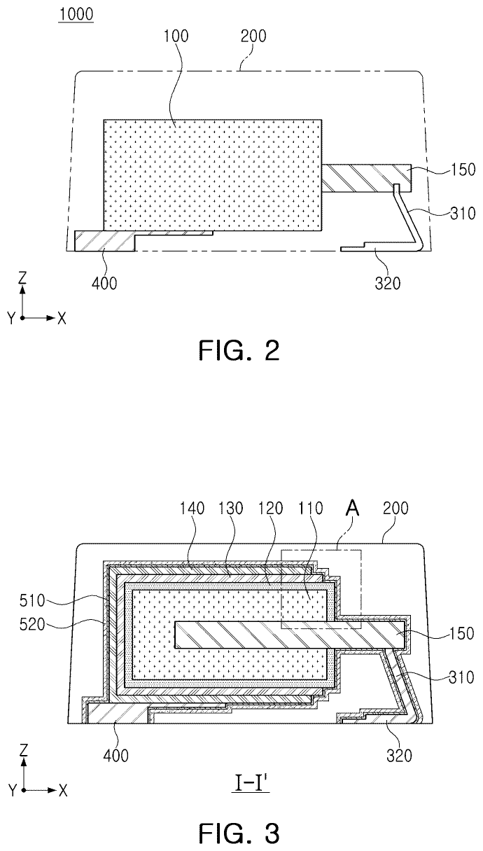

FIG. 1 is a perspective view of a tantalum capacitor according to the present disclosure. FIG. 2 is a side perspective view of the tantalum capacitor according to the present disclosure.

Referring to FIGS. 1 and 2, a tantalum capacitor 1000 according to the present exemplary embodiment may include a tantalum body 100 and a molded portion 200 and may further include an anode lead frame 300 and a cathode lead frame 400.

The tantalum body 100 may have a tantalum wire 150 exposed in the first direction (the X-direction) of the body. Here, the tantalum wire 150 may penetrate through at least a portion of a tantalum element 110 in the first direction (the X-direction). The tantalum wire 150 may be inserted into a mixture of tantalum powder and a binder to be installed so that the tantalum wire 150 is off-centered from the center before the mixed powder of the tantalum powder and the binder is compressed. That is, the tantalum body 100 may be formed by inserting the tantalum wire 150 into tantalum powder mixed with the binder to form the tantalum element having a desired size and then sintering the tantalum element in a high temperature and high vacuum (10⁻⁵ torr or less) atmosphere for about 30 minutes.

The molded portion 200 may cover the tantalum body 100 and may be formed so that one surface of a first connection portion 320 of the anode lead frame 300 and one surface of a cathode lead frame 400 are exposed.

The molded portion 200 of the tantalum capacitor according to the present disclosure may be formed by transfer-molding a resin, such as an epoxy molding compound (EMC), to surround the tantalum body 100. The molded portion 200 serves to protect the tantalum wire 150 and the tantalum body 100 from the outside.

The anode lead frame 300 may be electrically connected to the tantalum wire 150 and may serve as a terminal when mounted on a substrate. The anode lead frame 300 may include a first connection portion 320 and a first bent portion 310, and the first bent portion 310 may be inclined toward the tantalum body 100 with respect to the first connection portion 320. The first connection portion 320 of the anode lead frame 300 may be exposed to a second surface 2 of the molded portion 200. The first connection portion 320 may be exposed to a lower surface of the molded portion 200 and may serve as a terminal when mounted on a substrate. Here, the first connection portion 320 may be spaced apart from the tantalum body 100 and may function as an anode of the tantalum capacitor 1000 according to the present disclosure. To this end, the anode lead frame 300 may be formed of a conductive metal, such as nickel/iron alloy.

The cathode lead frame 400 may be connected to the tantalum body 100 and may serve as a terminal when mounted on a substrate. The cathode lead frame 400 may be disposed to be spaced apart from the anode lead frame 300 and be parallel to the first direction (the X-direction). The cathode lead frame 400 may be exposed to the second surface 2 of the molded portion 200. The cathode lead frame 400 may be exposed to the lower surface of the molded portion 200 and may serve as a terminal when mounted on a substrate and may function as a cathode of the tantalum capacitor 1000 according to the present disclosure. To this end, the cathode lead frame 400 may be formed of a conductive metal, such as nickel/iron alloy.

Meanwhile, although not illustrated in the drawings, the tantalum capacitor according to an exemplary embodiment in the present disclosure may further include a conductive adhesive layer to bond the cathode lead frame 400 to the tantalum body 100. Such a conductive adhesive layer may be formed, for example, by applying and curing a certain amount of a conductive adhesive including an epoxy-based thermosetting resin and conductive metal powder, such as silver (Ag), but the present disclosure is not limited thereto.

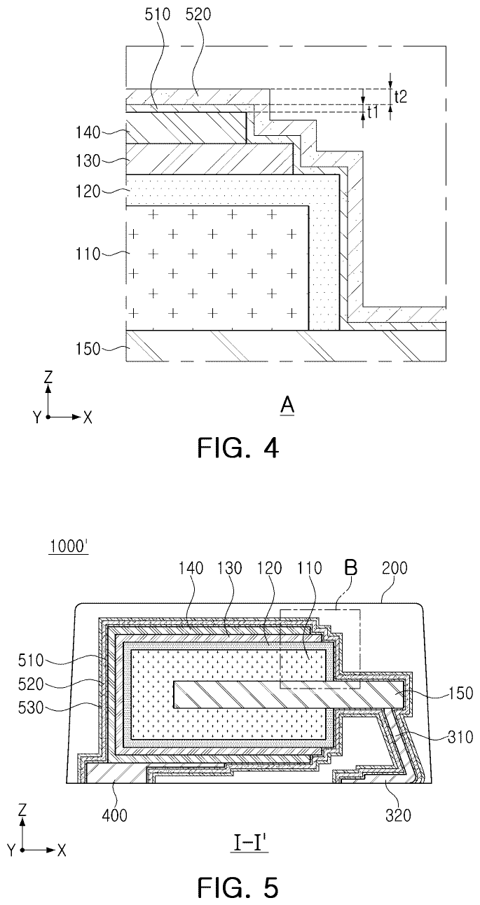

FIG. 3 is a cross-sectional view taken along line I-I′ in FIG. 1. FIG. 4 is an enlarged view of portion A in FIG. 3.

Referring to FIGS. 3 and 4, the tantalum body 100 of the tantalum capacitor 1000 according to an exemplary embodiment in the present disclosure includes the tantalum element 110 including tantalum powder, a conductive polymer layer 120 disposed on the tantalum element 110, a carbon layer 130 disposed on the conductive polymer layer, and a silver (Ag) layer 140 disposed on the carbon layer.

The tantalum capacitor may further include the tantalum wire 150 having an insertion region located inside the tantalum element 110 and a non-insertion region located outside the tantalum element 110.

The tantalum element 110 may be formed by sintering a molded body including metal powder and a binder.

Specifically, the tantalum element 110 may be manufactured by mixing and stirring metal powder, a binder, and a solvent at a certain ratio, compressing the mixed powder to be formed as a rectangular parallelepiped, and then sintering a resultant body under high temperature and high vibration.

The metal powder is not particularly limited as long as it may be used in the tantalum element 110 of the tantalum capacitor 1000 according to an exemplary embodiment in the present disclosure and may be tantalum (Ta) powder. However, without being limited thereto, the metal powder may be one or more selected from the group consisting of aluminum (Al), niobium (Nb), vanadium (V), titanium (Ti), and zirconium (Zr), and accordingly, an aluminum element, a niobium element, and the like, instead of the tantalum element, may be used.

The binder is not particularly limited and may be, for example, a cellulose-based binder.

The cellulose-based binder may be one or more selected from the group consisting of nitrocellulose, methyl cellulose, ethyl cellulose, and hydroxy propyl cellulose.

In addition, the tantalum wire 150 may be inserted and installed so as to be off-centered from the center before compressing the mixed powder.

According to an exemplary embodiment in the present disclosure, a dielectric oxide layer may be formed as an insulating layer on the tantalum element 110. That is, the dielectric oxide layer may be formed by growing an oxide film (Ta₂O₅) on a surface of the tantalum element 110 through a chemical process using an electrochemical reaction. Here, the dielectric oxide layer changes the tantalum element 110 into a dielectric. In addition, the conductive polymer layer 120 having a negative polarity may be applied to and formed on the dielectric oxide layer.

The conductive polymer layer 120 is not particularly limited and may include, for example, a conductive polymer.

Specifically, a conductive polymer may be formed by using chemical polymerization or electrolytic polymerization using EDOT (3,4-ethylenedioxythiophene), pyrrole monomer, or polypyrrole, and then may be formed as a cathode layer having a conductive polymer cathode on an external surface of the tantalum element 110 formed as an insulating layer.

That is, the conductive polymer layer 120 may be formed using a polymer slurry, and the polymer slurry may include at least one of polypyrrole, polyaniline, or EDOT (3,4-ethylenedioxythiophene). In addition, the conductive polymer layer 120 may include PEDOT:PSS (poly(3,4-ethylenedioxythiophene):poly(styrenesulfonate)). PEDOT:PSS may be produced by oxidative polymerization of EDOT using polystyrene sulfonate (PSS) as a template to balance charge.

Meanwhile, the carbon layer 130 is stacked on the conductive polymer layer 120. For example, the carbon layer may be stacked by dissolving carbon powder in an organic solvent including an epoxy-based resin, impregnating the tantalum element 110 with a solution in which the carbon powder is dissolved, and then drying the same at a certain temperature to volatilize the organic solvent.

In addition, the carbon layer 130 may serve to prevent silver (Ag) ions from passing therethrough.

Next, the silver (Ag) layer 140 formed of silver (Ag) paste may be formed on an upper surface of the carbon layer 130.

The silver (Ag) layer 140 may be stacked on the outside of the carbon layer 130 to improve conductivity.

In addition, the silver (Ag) layer 140 may improve conductivity for the polarity of the cathode layer, thereby facilitating electrical connection for polarity transfer.

FIG. 7 is a cross-sectional view of the related art tantalum capacitor.

The related art tantalum capacitor without a coating layer has a problem in that sufficient adhesion between a lead frame (or a tantalum body) and a molded portion is not secured, resulting in interfacial defects. In a high-temperature and high-humidity environment, vapor pressure may penetrate into the capacitor through an opened interface, deteriorating the reliability of the component (hereinafter, referred to as moisture absorption defect).

The tantalum capacitor 1000 according to the present disclosure includes first and second coating layers 510 and 520.

Referring to FIGS. 3 and 4, the first coating layer 510 may be disposed on at least a portion of the interface (e.g., first interface) between the tantalum body 100 and the molded portion 200.

In addition, the first coating layer 510 may be disposed on at least a portion of the interface (e.g., second interface) between the molded portion 200 and the anode lead frame 300 and the interface (e.g., third interface) between the molded portion 200 and the cathode lead frame 400.

The first coating layer 510 may serve to strengthen the interface between the tantalum body 100 and the molded portion 200 or between the lead frames 300 and 400 and the molded portion 200. In other words, sufficient interfacial bonding force may be secured to prevent moisture absorption defects.

The first coating layer 510 may extend to the second surface 2 of the molded portion 200. As the lead frames 300 and 400 extend to the second surface 2 of the molded portion 200, the interface between the molded portion on the second surface and the lead frame may have a structure vulnerable to penetration of external vapor pressure. As in the present disclosure, since the first coating layer 510 extends to the second surface 2 of the molded portion 200, penetration of external vapor pressure may be fundamentally blocked.

The first coating layer 510 may have a thickness t1 of more than 0 μm and less than or equal to 1 μm. Specifically, if the thickness of the first coating layer 510 exceeds 1 μm, cracking of the coating layer may occur and moisture penetration through the interface may be promoted.

The first coating layer 510 may include multifunctional alkoxy silane. The alkoxy silane has hydrophobicity, so it may prevent moisture penetration and contamination and may improve mechanical strength against bending stress through a curing reaction.

As an example, the first coating layer 510 may include a silane coupling agent. In this case, one end of a silicon (Si) atom of the first coating layer 510 may be covalently or hydrogen bonded to the molded portion 200 and the lead frames 300 and 400, and the other end of the silicon (Si) atom may be bonded to hydrophobic functional groups.

Specifically, the silane coupling agent may have two functional groups having different reactivity in one molecule, that is, a hydrophilic group and a hydrophobic group, and may be represented by [Chemical Formula 1] below.

X₃₋ₙ MeₙSi—R—Y (n=0, 1) [Chemical Formula 1]

Here, X is a functional group that chemically bonds with an inorganic material, and may be, for example, an alkoxy group (R—O) having an alkyl group (R) having 1 to 16 carbon atoms, such as methoxy (CH₃O—) or ethoxy (C₂H₅O—). X may be a hydrolyzable hydrophilic functional group.

Me may be a methyl group, and R may be an ethylene or propylene group, but are not limited thereto.

Y is a functional group that chemically bonds with an organic material and may be formed of, for example, amino group (—NH₂), vinyl group (CH₂CH—), acrylic group, methacryl group, isocyanate group (—N═C═O), mercapto group (SH—), urea group (—NHCONH₂), epoxy group, and the like but is not limited thereto. Y may be a nonhydrolyzable hydrophobic functional group.

More specifically, the first coating layer 510 may include an amino silane-based material. Specific examples may include, but are not limited to, aminopropyltrimethoxysilane (APTMS) and N-aminoethylaminopropyl trimethoxysilane (AEAPS). In the case of amino silane-based materials, ammonium ions (NH₄⁺) resulting from amino groups may appear strongly at about pH 10, and the growth of polysiloxane in the second coating layer 520, which is to be described below, may be promoted due to a condensation reaction.

The second coating layer 520 is disposed on the first coating layer 510. Specifically, the second coating layer 520 may be formed at the aforementioned interface along the first coating layer 510.

The tantalum capacitor 1000 according to the present disclosure may further improve moisture resistance reliability by disposing the second coating layer 520 on the first coating layer 510. In addition, when the tantalum body 100 expands due to moisture penetration, internal stress is likely to occur. Here, the second coating layer 520 having elasticity may be disposed between the tantalum body 100 and the molded portion 200 to have enhanced characteristics against internal stress.

That is, the second coating layer 520 serves to relieve stress occurring at the interface between the tantalum body 100 and the molded portion 200 or between the lead frames 300 and 400 and the molded portion 200. Since the second coating layer 520 acts as a buffer to absorb stress at the interface, the second coating layer 520 is formed to be thicker than a thickness of the first coating layer 510 described above.

The second coating layer 520 may have a thickness t₂ more than 10 μm and less than or equal to 50 μm. If the thickness of the second coating layer 520 exceeds 50 μm, the coating layer may be exposed to the outside of the chip, as to be described below, thereby increasing the probability of defect occurrence.

The second coating layer 520 may include polysiloxane. As specific examples, the second coating layer 520 may be polydimethylsiloxane, polymethylhydrosiloxane, polymethylphenylsiloxane, and polydiphenylsiloxane, but is not limited thereto.

The polysiloxanes are materials having a low storage modulus at room temperature and good recovery properties. Specifically, when the second coating layer 520 is formed with the aforementioned polysiloxane, the second coating layer 520 may have a storage modulus value (range) as illustrated in [Table 1] below depending on the temperature.

TABLE 1

| | Measurement | |
|---|---|---|
| | temperature | Storage Modulus range [MPa] |
| Second coating | 25° C. | More than 50 and 100 or less |
| layer | 85° C. | More than 0 and 20 or less |
| | 105° C. | 0 More than 0 and 10 or less |
| | 125° C. | More than 0 and 5 or less |
| | 135° C. | More than 0 and 3 or less |

When the second coating layer 520 has such storage modulus values as in the range illustrated in [Table 1], a high stress reduction effect may be obtained. However, the present disclosure is not limited to the storage modulus values.

The coating layer 500 may be formed on a semi-finished tantalum capacitor by dipping, spraying, jetting, or deposition, but is not limited thereto. Here, the semi-finished product state may refer to a state before the molded portion 200 forming the exterior of the tantalum capacitor is formed.

In the tantalum capacitor according to the present disclosure, a plurality of coating layers 500 may be arranged in the manner as described above to strengthen the interface between the lead frame (or the tantalum body) and the molded portion, thereby lowering the moisture absorption rate and thus ensuring reliability. In addition, by using a material having excellent elasticity, enhanced characteristics may be obtained against internal stress when the internal element expands due to moisture penetration.

A thickness of each of the first, second, and third coating layers may refer to an average thickness, and the average thickness may be measured in the following manner. A cross-section of the tantalum capacitor in the first direction (the X-direction)−third direction (the Z-direction) is polished to a depth of about ½ in the second direction (the W-direction) to collect a cross-sectional sample as illustrated in FIG. 4. The thickness and arrangement of the first, second, and third coating layers on an interface region with the mold may be checked by observing the collected cross-sectional sample with a scanning electron microscope (SEM) at a magnification of 500 to 20,000. In the cross-sectional sample as illustrated in FIG. 4, an average thickness may be obtained by measuring a length (t₁ or t₂) of the coating layer in the third direction (the Z-direction) at five points and calculating the arithmetic mean at the five points. Other methods and/or tools appreciated by one of ordinary skill in the art, even if not described in the present disclosure, may also be used.

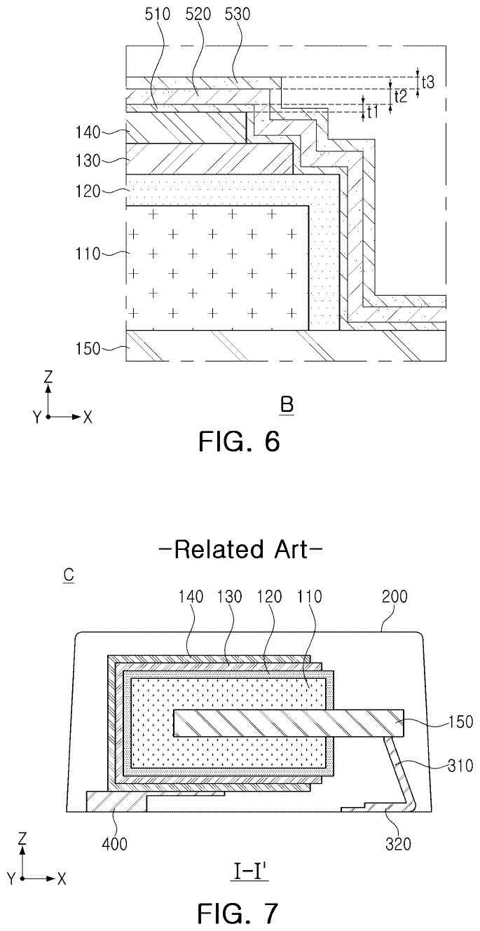

FIG. 5 is a cross-sectional view taken along line I-I′ of a modified example of the present disclosure. FIG. 6 is an enlarged view of portion B in FIG. 5.

A tantalum capacitor 1000′ according to a modified example of the present disclosure may further include a third coating layer 530. The third coating layer 530 may be disposed on the second coating layer 520.

The third coating layer 530 may include a material having a low moisture permeability, which may further improve the moisture resistance reliability of the tantalum capacitor. Specifically, the third coating layer 530 may include polysiloxane and polyimide. A water vapor transmission rate (WVTR) of the third coating layer 530 may be 1.3 g/m² day or less.

The third coating layer 530 may have a thickness t₃ more than 1 μm and less than or equal to 20 μm. The third coating layer 530 may secure sufficient moisture resistance reliability in a range of more than 1 μm and 20 μm or less and may prevent exterior defects of the coating layer.

The sum of the thicknesses of the first to third coating layers 510, 520, and 530 may be 60 μm or less. If the sum of the thicknesses exceeds 60 μm, the coating layers may be exposed to the exterior of the chip, thereby increasing the probability of defect occurrence.

Descriptions of components other than the third coating layer 530 are redundant and thus are omitted here.

One effect of the present disclosure is to provide the tantalum capacitor having excellent reliability by strengthening the interface and lowering the moisture absorption rate.

Another effect of the present disclosure is to provide the tantalum capacitor having enhanced characteristics against stress.

While exemplary embodiments have been illustrated and described above, it will be apparent to those skilled in the art that modifications and variations could be made without departing from the scope of the present disclosure as defined by the appended claims.

What is claimed is:

1. A tantalum capacitor comprising:
a tantalum body including a tantalum element including tantalum particles, a conductive polymer layer disposed on the tantalum element, and a tantalum wire penetrating through at least a portion of each of the tantalum element and the conductive polymer layer in a first direction;
a molded portion including a fifth surface and a sixth surface facing in the first direction, a third surface and a fourth surface facing in a second direction, and a first surface and a second surface facing in a third direction, the molded portion surrounding the tantalum body;
a first coating layer disposed on at least a portion of a first interface between the tantalum body and the molded portion; and
a second coating layer disposed on the first coating layer,
wherein the second coating layer is thicker than the first coating layer.

2. The tantalum capacitor of claim 1, wherein the first coating layer includes a multifunctional alkoxy silane.

3. The tantalum capacitor of claim 1, wherein the second coating layer includes polysiloxane.

4. The tantalum capacitor of claim 1, wherein the first coating layer has a thickness of more than 0 μm and 1 μm or less.

5. The tantalum capacitor of claim 1, wherein the second coating layer has a thickness of more than 10 μm and 50 μm or less.

6. The tantalum capacitor of claim 1, wherein the second coating layer is on a surface of the first coating layer.

7. The tantalum capacitor of claim 1, further comprising a third coating layer disposed on the second coating layer.

8. The tantalum capacitor of claim 7, wherein the third coating layer includes polyimide.

9. The tantalum capacitor of claim 7, wherein the third coating layer has a thickness of more than 1 μm and 20 μm or less.

10. The tantalum capacitor of claim 7, wherein a sum of the thicknesses of the first to third coating layers is 60 μm or less.

11. The tantalum capacitor of claim 1, wherein
the tantalum body further includes:
a carbon layer disposed on the conductive polymer layer; and
a silver (Ag) layer disposed on the carbon layer.

12. The tantalum capacitor of claim 1, further comprising:
an anode lead frame extending to the second surface of the molded portion and electrically connected to the tantalum wire; and
a cathode lead frame spaced apart from the anode lead frame and extending to the second surface of the molded portion.

13. The tantalum capacitor of claim 12, wherein
the first coating layer is on at least a portion of a second interface between the molded portion and the anode lead frame, and
the first coating layer is on at least a portion of a third interface between the molded portion and the cathode lead frame.

14. A tantalum capacitor comprising:
a tantalum body including a tantalum element including tantalum particles, a conductive polymer layer disposed on the tantalum element, and a tantalum wire penetrating through at least a portion of each of the tantalum element and the conductive polymer layer in a first direction;
a molded portion including a fifth surface and a sixth surface facing in the first direction, a third surface and a fourth surface facing in a second direction, and a first surface and a second surface facing in a third direction, the molded portion surrounding the tantalum body;
an anode lead frame extending to the second surface of the molded portion and electrically connected to the tantalum wire;
a cathode lead frame spaced apart from the anode lead frame and extending to the second surface of the mold portion;
a first coating layer disposed on at least a portion of a second interface between the molded portion and the anode lead frame and a third interface between the molded portion and the cathode lead frame; and
a second coating layer disposed on the first coating layer.

15. The tantalum capacitor of claim 14, wherein
the first coating layer includes a multifunctional alkoxy silane, and
the second coating layer includes polysiloxane.

16. The tantalum capacitor of claim 14, further comprising:
a third coating layer disposed on the second coating layer,
wherein the third coating layer includes polyimide.

17. The tantalum capacitor of claim 14, wherein the first coating layer extends to the second surface of the molded portion.

18. The tantalum capacitor of claim 15, wherein the second coating layer is thicker than the first coating layer.

19. The tantalum capacitor of claim 15, wherein the multifunctional alkoxy silane includes aminopropyltrimethoxysilane, N-aminoethylaminopropyl trimethoxysilane, or both.
